(19) United States
(12) Patent Application Publication
(10) Pub. No.: US 2025/0169644 A1
(43) Pub. Date: May 29, 2025

(54) GRIDDLE HAVING INTERNAL RESERVOIR FOR LIQUID HEAT TRANSFER MEDIUM

(71) Applicant: STEARNS PRODUCT DEVELOPMENT CORPORATION, Perris, CA (US)

(72) Inventor: Howard Frantz, Irvine, CA (US)

(21) Appl. No.: 18/958,404

(22) Filed: Nov. 25, 2024

Related U.S. Application Data
(60) Provisional application No. 63/602,642, filed on Nov. 26, 2023.

(51) Int. Cl. A47J 36/24; A23L 5/10; A47J 36/32; A47J 37/06; F28D 15/00

(52) U.S. Cl. CPC A47J 36/2405; A23L 5/13; A47J 36/32; A47J 37/067; F28D 15/00

(57) ABSTRACT

A griddle configured for use with a liquid heating medium includes a griddle plate and a reservoir body coupled to the griddle plate. The reservoir body and griddle plate collectively define a reservoir configured to receive a liquid heating medium. A port is in fluid communication with the reservoir, with the port being open to the atmosphere to facilitate maintaining of the reservoir at atmospheric pressure. A heat element is in thermal communication with the reservoir and is configured to impart heat to the liquid heating medium located within the reservoir.

### CROSS-REFERENCE TO RELATED APPLICATIONS

This application claims the benefit of U.S. Provisional Application Ser. No. 63/602,642, filed Nov. 26, 2023, the contents of which are expressly incorporated herein by reference.

### STATEMENT RE: FEDERALLY SPONSORED RESEARCH/DEVELOPMENT

Not Applicable

### BACKGROUND

### 1. Technical Field

The present disclosure relates generally to a griddle, and more specifically to a griddle using a liquid heating medium at atmospheric pressure for heating a griddle surface.

### 2. Description of the Related Art

The griddle is a fixture in almost every commercial foodservice establishment, ranging from fast food restaurants to fine dining restaurants. Most commercials griddles have several features in common. A first common feature is a thick steel griddle plate, oftentimes about 1-inch thick, surrounded on the sides by raised walls and in the rear by a backsplash to keep any grease or other food contained within the griddle surface. The front of the griddle is typically open (e.g., does not include a raised side) to allow the cook to add and remove food without impediment. Another common feature is a grease trough, typically extending across the front of the griddle to allow grease drained from the front to the captured.

The griddle plate on conventional commercial griddles may be heated either through electric heat elements or via gas combustion. When electric heat elements are used, the heat elements may be bolted to the bottom side of the griddle plate or embedded within the griddle plate. When natural gas or propane is used in the heating clement, an open flame is typically fired under the griddle plate, much like a gas stove. The natural gas or propane may also be used to generate an indirect flame used to heat an infrared burner located under the griddle plate that radiates heat to the bottom surface of the griddle plate.

An operator may set a desired temperature for the griddle plate by either dial or digital control. One or more temperature sensors may be embedded in or attached to the bottom of the griddle plate to sense the temperature of the metal. If the temperature falls below a certain point the heat source may be activated, and when the sensor reaches the desired temperature the heat source may be turned off.

Although conventional griddles are widely used in restaurant establishments, there are several well-known disadvantages associated with conventional griddle technology. One disadvantage is that there are difficulties in avoiding hot and cold spots on the griddle surface using conventional griddle technology. It is common to experience variations of ±60° F. at any time along the surface of the griddle. This makes it difficult to obtain consistent cooking results. Another deficiency is that the griddle may overshoot or undershoot the desired temperature. For instance, even though a griddle may be set at 350° F., the heat source may be running at over 1200° F. This high temperature may be needed to quickly inject heat into the massive 1-inch thick steel slab. This also tends to introduce large swings in temperature within the griddle plate as the heat source cycles on and off.

The aforementioned issues prompted the development of a griddle that employs a different heating modality. In particular, steam-based griddles were developed which generate steam to heat the griddle plate. The griddle plate resides over a sealed compartment partially filled with water. When heated, the water creates a layer of super-heated steam. The steam may condense on the bottom side of the griddle plate, with the condensation releasing latent energy in the steam and bringing the griddle plate to a desired temperature.

While the steam-based griddles may produce a more even cooking temperature along the entire griddle surface, there are several disadvantages associated with the steam based systems. A first disadvantage is the relatively high cost associated with the steam-based griddles. To obtain water or steam above 212° (at sea level) Fahrenheit, the griddle must be pressurized to generate the super-heated steam, which is similar to a pressure cooker. To safely build a commercial griddle to withstand such pressures requires expensive materials and sophisticated labor intensive fabrication techniques, which drives up the cost of the steam-based griddles. Another drawback associated with steam-based griddles is their temperature ceiling, which is typically around 400° F. Due to the high pressures exerted when the griddle is hot, steam-based griddles can typically not safely produce temperatures above that level due to the extreme pressures. Yet another deficiency associated with steam-based griddles is that they are typically limited to one temperature setting for the entire griddle, and thus, multiple items cannot be cooked on the griddle at the same time. For instance, during breakfast, eggs may require a cooking temperature of 280° F. while hash browns may be cooked at 475° F. Such a temperature profile may not be achievable at the same time on a single griddle surface.

Accordingly, there is a need in the art for a griddle that addresses the temperature control issues associated with conventional griddles without the cost and limitations of steam-based griddles. Various aspects of the present disclosure address this particular need, as will be discussed in more detail below.

### BRIEF SUMMARY

In accordance with one embodiment of the present disclosure, there is provided a griddle configured for use with a liquid heating medium. The griddle includes a griddle plate and a reservoir body coupled to the griddle plate. The reservoir body and griddle plate collectively define a reservoir configured to receive a liquid heating medium. A port is in fluid communication with the reservoir, with the port being open to the atmosphere to facilitate maintaining of the reservoir at atmospheric pressure. A heat element is in thermal communication with the reservoir and is configured to impart heat to the liquid heating medium located within the reservoir.

The heat element may be located within the reservoir or outside of the reservoir. Furthermore, the heat element may be an electric heat element or a gas heat element.

The griddle may include a temperature sensor in thermal communication with the reservoir, with the temperature sensor being configured to sense a temperature of the liquid heating medium.

The griddle plate may include an outer griddle surface and an inner griddle surface opposite the outer griddle surface and facing the reservoir. The griddle plate may include a griddle plate thickness as the distance between the outer griddle surface and the inner griddle surface, with the griddle plate thickness being less than 1 inch. The griddle plate thickness may be between 0.1 inches and 1.0 inch.

The griddle may include at least one dividing wall located within the reservoir to separate the reservoir into two regions. The heat element may include a first heat element positioned within a first region of the two regions. The griddle may further comprise a second heat element positioned within a second region of the two regions. The first heat element and the second heat element may be independently operable.

The griddle may be configured to generate a temperature on an outer surface of the griddle above 400 degrees Fahrenheit.

According to another embodiment, there is provided a griddle configured for use with a liquid heating medium. The griddle comprises a griddle plate having an outer surface and an inner surface to define a griddle plate thickness therebetween, with the griddle plate thickness being less than 1 inch. A reservoir body is coupled to the griddle plate such that the reservoir body and griddle plate collectively define a reservoir configured to receive a liquid heating medium. A heat element is in thermal communication with the reservoir and is configured to impart heat to the liquid heating medium located within the reservoir.

According to another embodiment, there is provided a method of operating a griddle. The method includes filling a reservoir with a liquid heating medium through a port in fluid communication with the reservoir. The reservoir is defined by a griddle plate and a reservoir body coupled to the griddle plate, with the reservoir being filled until the liquid heating medium contacts the griddle plate. The method additionally includes heating the liquid heating medium with a heat element in thermal communication with the reservoir.

The port may be open to the atmosphere during the heating step.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is an upper perspective view of a griddle configured for use with a liquid heating medium in accordance with an embodiment of the present disclosure;

FIG. 2 is a side cross sectional view of the griddle of FIG. 1 illustrating an internal reservoir for the liquid heating medium and a heating element within the reservoir;

FIG. 3 is a front cross sectional view of the griddle depicted in FIG. 2;

FIG. 4 is a side cross sectional view of an embodiment of the griddle including a heating element outside of the reservoir;

FIG. 5 is top view of a griddle having multiple, independently controllable heating zones; and

FIG. 6 is a front cross sectional view of the griddle depicted in FIG. 5.

Common reference numerals are used throughout the drawings and the detailed description to indicate the same elements.

### DETAILED DESCRIPTION

The detailed description set forth below in connection with the appended drawings is intended as a description of certain embodiments of a griddle and is not intended to represent the only forms that may be developed or utilized. The description sets forth the various structure and/or functions in connection with the illustrated embodiments, but it is to be understood, however, that the same or equivalent structure and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

Various aspects of the present disclosure relate to a griddle configured to utilize liquid as a heat transfer medium between a heat source and a griddle plate. The griddle includes a reservoir cavity that may be completely filled with liquid and which may remain non-pressurized during operation. In this regard, the griddle additionally include a port in communication with the reservoir that is open to the atmosphere to facilitate any pressure relief that may occur as the liquid medium is heated. The griddle may be capable of creating a more uniform temperature across the cooking surface, wherein hot spots and cold spots are reduced or eliminated. Furthermore, certain embodiments of the griddle may be capable of including multiple cooking zones capable of being operated at distinct temperatures to facilitate concurrent cooking of multiple food items. The ability to operate the griddle at atmospheric pressure may reduce the overall cost and complexity of the griddle, particularly compared to conventional steam-based griddles.

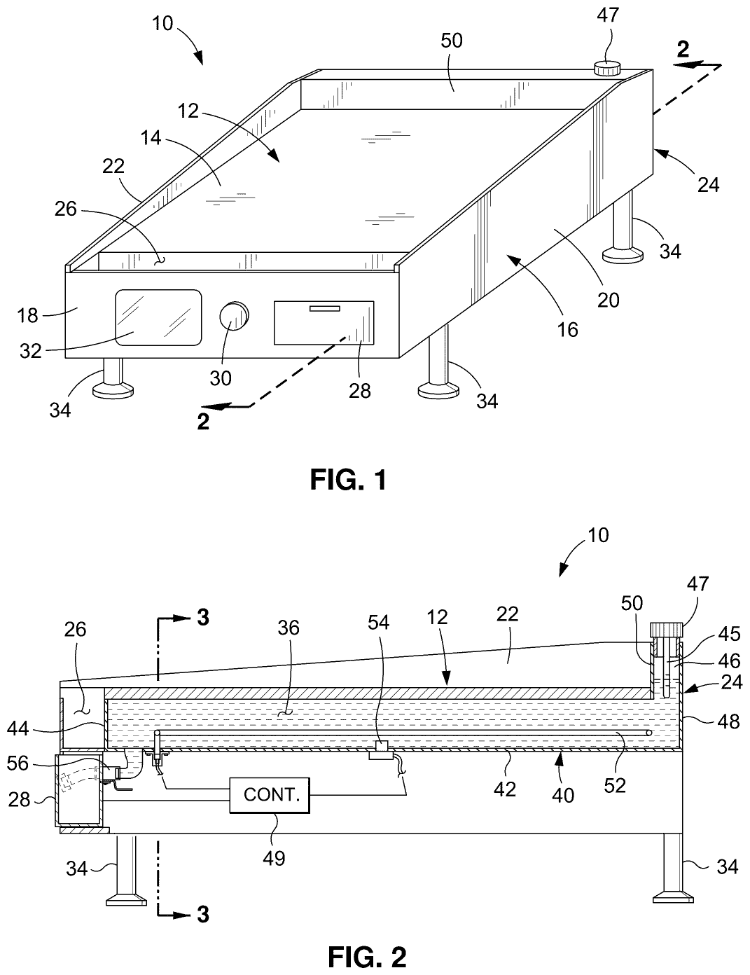

Referring now to FIG. 1, there is depicted a griddle 10 having a griddle plate 12 including an upper plate surface 14 configured to be heated for cooking food. The griddle 10 includes a base frame 16 surrounding the griddle plate 12, with the base frame 16 including a front wall 18, a pair of sidewalls 20, 22, and a rear wall 24. Each wall 18, 20, 22, 24 may include a lower edge and an upper edge. The front wall 18 may be configured such that the upper edge thereof may be coplanar with, or slightly recessed from, a plane defined by the upper plate surface 14. In this respect, the front wall 18 may not impede the user from placing food on, or removing food from, the griddle plate 12. Conversely, each of the pair of sidewalls 20, 22, as well as the rear wall 24, may extend above the griddle plate 12 to provide a barrier around the griddle plate 12 so as to assist in retaining food items on the griddle plate 12, as well as to provide a barrier for grease or oils that may splash upwardly from the griddle plate 12. The pair of sidewalls 20, 22 may include an angled upper edge, such that the height of the sidewalls is smaller at the front end portion and larger at the rear end portion. The smaller height in the front may be desirable so as not to interfere with the cooking activity of the user (e.g., movement of food items and utensils used during cooking). The front wall 18 may be slightly spaced from a front edge of the griddle plate 12 to define a grease trough 26 for catching grease from the griddle plate 12. In this regard, the upper plate surface 14 may have a slight angle toward the grease trough 26 to urge grease to flow toward the grease trough 26.

The griddle 10 may additionally include a grease drawer 28 which may collect grease that falls into the grease trough 26. The grease drawer 28 may be accessible through an opening in the front wall 18, which allows for removal of the grease drawer 28 to unload the accumulated grease, and then subsequent placement of the grease drawer 28 back in place.

A drain port 30 may extend through the front wall 18 to allow for draining of the liquid medium from an internal reservoir, as will be explained in more detail below. The drain port 30 may accommodate a hose that may be used to drain the liquid heating medium into a desired receptacle (e.g., a bucket).

A controller interface 32 may also be located at the front wall 18, with the controller interface 32 being configured to receive user inputs for controlling operation of the griddle 10. In this regard the controller interface 32 may enable temperature control, timing control, operation in certain modes (e.g., cooking mode, cleaning mode, drain mode, etc.). The controller interface 32 may include a touch screen, dials, buttons, levers, switches or other input devices known by those skilled in the art.

The griddle 10 may further include a plurality of legs 34, each of which includes a respective foot for stabilizing and supporting the griddle 10 on an underlying support surface. Each leg 34 may be independently adjustable in length to facilitate leveling of the upper plate surface 14 or achieving a desired angular orientation of the griddle 10.

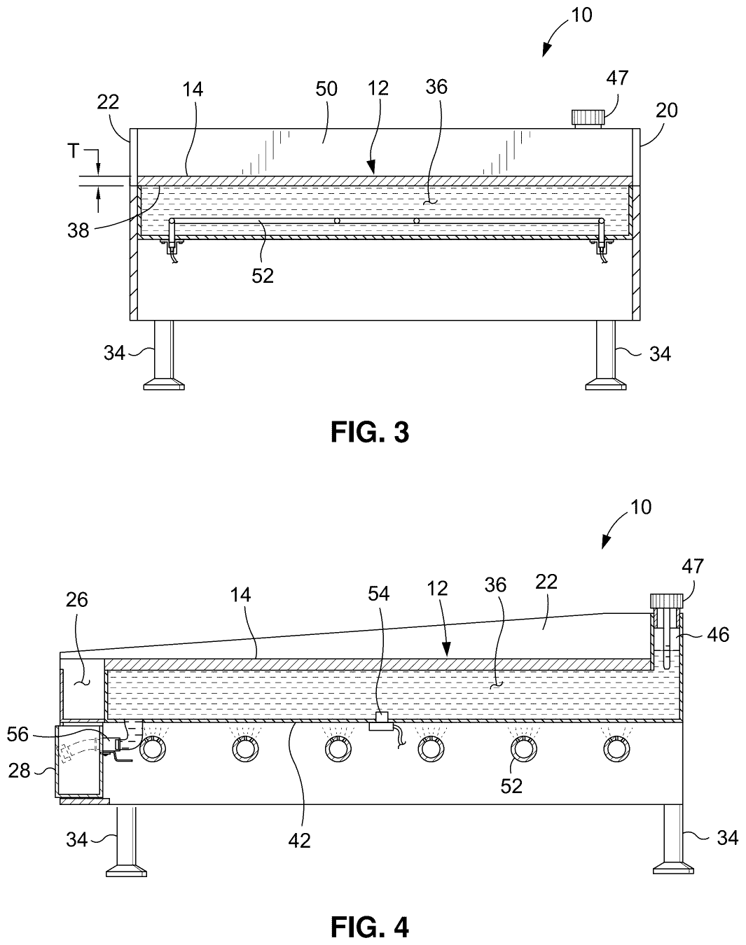

Referring now to FIGS. 2 and 3, there is depicted a cross sectional view to illustrate the inside of the griddle 10. As can be seen, the griddle 10 includes a reservoir 36 below the griddle plate 12, with the reservoir 36 being configured to retain the liquid heating medium. The reservoir 36 may be defined by a lower plate surface 38 of the griddle plate 12, as well as a reservoir body 40. The reservoir body 40 may include a lower reservoir wall 42, a front reservoir wall 44, and the rear wall 24. The rear wall 24 may be configured to include a portion of the reservoir 36 and may also define a port 46 in fluid communication with the reservoir 36, with the port 46 being open to the atmosphere to facilitate maintaining of the reservoir 36 at atmospheric pressure during operation of the griddle 10. It is contemplated that during use of the griddle 10, the reservoir 36 may be filled with liquid heating medium until at least the liquid heating medium is in contact with the lower plate surface 38 of the griddle plate 12. The reservoir 36 may also extend into the rear wall 24 to accommodate expansion of the liquid heating medium as the temperature of the liquid heating medium increases. In this regard, the volume of the liquid heating medium may expand by approximately 10-15% as the temperature of the liquid heating medium increases from room temperature to a desired cooking temperature. Thus, the void within the rear wall 24 may help to accommodate such expansion. A level sensor 45 may be located in the rear wall 24 to measure the level of the liquid heating medium therein.

The port 46 may be configured to serve as an access point to the reservoir 36 to enable filling of the reservoir 36 with liquid heating medium, and also as a barrier to entry of inadvertent debris or water therein. In this regard, a cap 47 may be secured to the port 46, with the cap 47 being configured to allow for pressure balancing between the reservoir 36 and the ambient environment. Thus, the cap 47 may not fluidly seal the reservoir 36, but may instead provide a physical barrier against inadvertent entry of debris or water. In alternative embodiments, the port 46 may include a tube that extends at an angle and having an opening that is disposed about an axis angled from the vertical to avoid debris or water from entering the port. It is contemplated that the port 46 may include one or more sensors or float switches in communication with a controller 49 to measure the level of the liquid heating medium to provide an alert to the user when additional liquid is required.

The controller 49 may serve as a communication hub between the various sensors, heat elements, controller interface 32, or other electrical components on the griddle 10. The controller 49 may include necessary hardware (e.g., processor(s), memory, etc.) needed to implement the functionalities described herein. In certain embodiments, the controller 49 may be integrated with the controller interface 32, while in other embodiments, the controller interface 32 may include user-facing hardware (display, touchscreen, etc.), whereas the controller 49 may include the non-user-facing hardware.

To accommodate portions of the reservoir 36 as well as the port 46, the rear wall 24 may include an outer rear wall 48 and an inner rear wall 50 spaced from each other. The outer rear wall 48 may extend upwardly from the lower reservoir wall 42, while the inner rear wall 50 may extend upwardly from the griddle plate 12.

The griddle 10 additionally includes a heat element 52 adapted for heating the liquid heating medium. In this regard, the heat element 52 is in thermal communication with the reservoir 36 and is configured to impart heat to the liquid heating medium located within the reservoir 36. In the embodiment depicted in FIG. 2, the heat element 52 is an electric heat clement located within the reservoir 36 and immersed within the liquid heat medium. The heat element 52 may be configured to wind or bend through the liquid heating medium to increase surface contact between the liquid heating medium and the heat element 52 to more effectively transfer heat from the heat clement 52 to the liquid heating medium. According to one embodiment, the heat element 52 may penetrate through the lower reservoir wall 42 from below the reservoir 36 to extend into the reservoir 36. A gasket or other sealing element may be used to prevent leakage of liquid out of the reservoir 36 through the opening which the heat element 52 enters the reservoir 36. Wiring or cables for power signals or control signals may extend under the reservoir 36 to a power source (e.g., electrical outlet or battery), or to the controller 49.

The griddle 10 may also include a temperature sensor 54 in thermal communication with the reservoir 36 and in operative communication with a controller. In the embodiment depicted in FIG. 2, the temperature sensor 54 includes a probe extending into the liquid heating medium. The temperature sensor 54 may be configured to sense a temperature of the liquid heating medium and send corresponding temperature data to the controller 49 which may implement certain control functionalities based on the temperature data received form the temperature sensor.

The griddle 10 may include several features which are significant improvements over conventional griddles. A primary feature of the griddle 10 is the ability to operate the griddle 10 without causing pressurization of the reservoir 36, which is in direct contrast to certain conventional griddles which operate by generating steam to heat the griddle plate. Thus, certain conventional griddles are constructed in a manner to structurally support an increase in pressure (e.g., welded structural members for added strength), while the griddle 10 does not have to handle a pressurized environment.

Another structural feature common to conventional griddles is a very thick steel griddle plate, oftentimes having a thickness of at least 1 inch. A thick griddle plate may be needed in conventional griddles to act as a high temperature heat sink. Conventional steam-based griddles may use a slightly thinner plate, however, as noted above, additional welding is required in view of the pressurized environment. The slightly thinner plate of conventional steam-based griddles allows for quicker heat transfer between the steam and the food product because steel has a low thermal conductivity, and the thinner plate allows for quicker response. Conversely, the griddle plate 12 in the griddle 10 may have a much smaller thickness in view of the fact that the griddle plate 12 is not acted upon by a pressurized reservoir, nor is the griddle plate 12 needed to function as a heat sink, as heat is stored in the liquid heating medium. The extremely thin plate allows for even faster heat transfer between the fluid medium and the food product. The thickness T of the griddle plate 12 is defined by the distance between the upper plate surface 14 and the opposing lower plate surface 38. The griddle plate thickness may be less than 1 inch and may vary between 0.1 inches and 1.0 inch. Having a thinner griddle plate 12 may reduce the overall weight of the griddle 10 and may also reduce the overall cost thereof.

Another significant feature of the griddle 10 is that the reservoir 36 may be configured to be filled with enough liquid heating medium until the liquid heating medium is in direct contact with the lower plate surface 38. This is distinguishable from steam-based griddles, which use small amounts of water to generate the steam needed to heat the griddle. In the steam-based griddles, the water does not contact the griddle plate. Rather, the steam-based griddles require sufficient space between the water the griddle plate to accommodate the steam. The griddle 10 does not require steam to heat the griddle plate 12, and instead, relies on direct heat transfer from the liquid heat medium to the griddle plate. To avoid having the liquid heating medium boil off and evaporate into the atmosphere, the liquid should have a boiling point above the maximum griddle temperature, which may be approximately 450 degrees Fahrenheit. High smoke point cooking oil such as safflower oil or a high quality food grate heat transfer medium, such as JAX Therma-Flo (having a boiling point of approximately 600 degrees Fahrenheit) are examples of liquid heating mediums usable in the griddle 10. The griddle 10 may be configured to generate a temperature on an outer surface of the griddle above 400 degrees Fahrenheit.

Furthermore, the griddle 10 may be configured to enhance the heat transfer between the liquid heating medium and the bottom of the griddle plate 12 when cold food is thrown on the griddle 10. The laws of thermodynamics dictate that cooler liquids will sink and warmer liquids will rise. Thus, as cold food is placed on the griddle plate 12, the underlying portion of the griddle plate 12 may cool, which in turn, may cool the directly adjacent liquid. That cooled liquid may sink and be replaced with hotter liquid from below. This natural convective movement may keep the griddle plate 12 at or near the set temperature point to reduce any hot or cold spots. Furthermore, fins or studs can be attached to the bottom of the griddle plate 12 to increase the effective surface area and accelerate convective heat transfer between the liquid heating medium and the griddle plate 12. In other embodiments, agitation can also be utilized to maintain movement of the liquid heating medium and further improve convective heat transfer. The agitation may be implemented by intermittent thermal pulses to create passive convective currents. Furthermore, an external recirculation pump may keep the liquid moving within the reservoir, or a motor driven impeller may continuously agitate the liquid within the reservoir 36.

FIG. 2 additionally depicts a drain valve 56 (e.g., a ball valve) in communication with the drain port 30. The drain valve 56 may remain closed to keep the liquid heating medium within the reservoir 36. However, to drain the liquid heating medium, such as during routine maintenance and care, the drain valve 56 may be opened, to allow the liquid heating medium to be drained from the reservoir 36 via the drain port 30.

Referring now specifically to FIG. 4, there is depicted an embodiment of the griddle 10 having heat element 52 located outside of the reservoir 36. In particular, the heat element 52 is located in an area below the reservoir 36. Furthermore, the heat element 52 depicted in FIG. 4 is a gas powered heat element (e.g., burner tube(s)) capable of generating an open flame which may contact lower reservoir wall 42 to impart heat on the liquid heating medium within the reservoir 36. The gas version may be desirable for kitchens that are already plumbed for gas appliances. The griddle 10 having a gas heat element 52 may additionally include a flue (not shown) positioned near the rear of the griddle 10 to vent combustion gases. Although FIG. 4 depicts tubing extending in a side-to-side direction, it is contemplated that the tubing may also extend in a front-to-back direction.

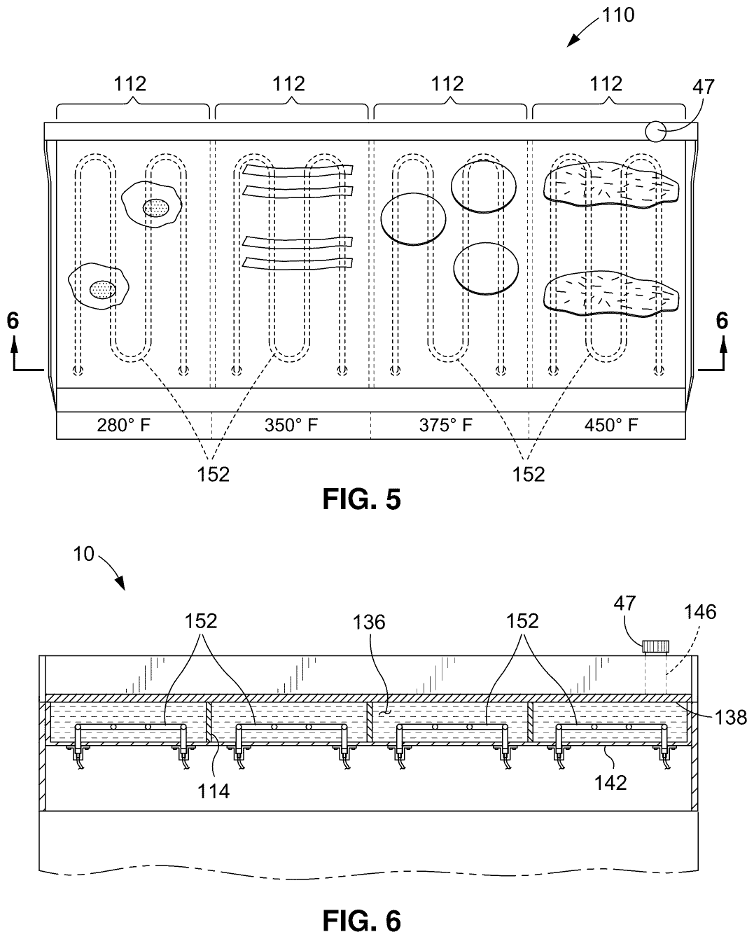

Referring now to FIGS. 5 and 6, there is depicted a griddle 110 having multiple cooking zones 112, where in each cooking zone may have a distinct cooking temperature. The griddle 110 is similar to the griddle 10 discussed above, and thus the following discussion will focus on the unique features of griddle 110 relative to the griddle 10.

The griddle 110 includes multiple heat elements 152 to achieve different cooking temperatures in the various cooking zones 112. The cooking zones 112 may be separated by dividing walls 114 extending between the lower reservoir wall 142 to the lower plate surface 138. It is contemplated that the reservoir 136 may extend through all cooking zones 112, such that only one port 146 is needed to keep the reservoir 136 at ambient pressure, while also filling the liquid heating medium within the various cooking zones 112. In this regard, the reservoir 136 may include separate reservoir zones delineated by the dividing walls 114, and a manifold may fluidly connect the separate reservoir zones, with the port 146 being in fluid communication with the manifold. Thus, the single port 146 may be used to fill all of the reservoir zones, via the manifold. It is also contemplated that the dividing walls 114 may include one or more openings therein to enable filling/draining of the reservoir zones through a single inlet port or drain port. However, in other embodiments, it is contemplated that each cooking zone 112 may include a fluidly isolated reservoir, with each reservoir having a dedicated port 146 (inlet) and drain port.

In addition to including separate heat elements 152, each cooking zone 112 may include a dedicated temperature sensor and controller. Alternatively, it is contemplated that a universal controller may be used to control the various heating elements 152. The cooking zones 112 may have a width of approximately 12 inches, such that adjacent dividing walls are 12 inches apart. Thus, a griddle 110 that is 24 inches wide may have two separately controllable cooking zones 112, while a 48 inch wide griddle 110 may include four separately controllable cooking zones 112.

The particulars shown herein are by way of example only for purposes of illustrative discussion, and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A griddle configured for use with a liquid heating medium, the griddle comprising:
a griddle plate;
a reservoir body coupled to the griddle plate such that the reservoir body and griddle plate collectively define a reservoir configured to receive a liquid heating medium;
a port in fluid communication with the reservoir, the port being open to the atmosphere to facilitate maintenance of the reservoir at atmospheric pressure; and
a heat element in thermal communication with the reservoir and configured to impart heat to the liquid heating medium located within the reservoir.

2. The griddle recited in claim 1, wherein the heat element is located within the reservoir.

3. The griddle recited in claim 1, wherein the heat element is located outside of the reservoir.

4. The griddle recited in claim 1, wherein the heat element is an electric heat element.

5. The griddle recited in claim 1, wherein the heat element is a gas heat element.

6. The griddle recited in claim 1, further comprising a temperature sensor in thermal communication with the reservoir, the temperature sensor being configured to sense a temperature of the liquid heating medium.

7. The griddle recited in claim 1, wherein the griddle plate includes an outer griddle surface and an inner griddle surface opposite the outer griddle surface and facing the reservoir, the griddle plate having a griddle plate thickness as the distance between the outer griddle surface and the inner griddle surface, the griddle plate thickness being less than 1 inch.

8. The griddle recited in claim 7, wherein the griddle plate thickness is between 0.1 inches and 1.0 inch.

9. The griddle recited in claim 1, further comprising at least one dividing wall located within the reservoir to separate the reservoir into two regions.

10. The griddle recited in claim 9, wherein the heat element includes a first heat element positioned within a first region of the two regions, the griddle further comprising a second heat element positioned within a second region of the two regions, the first heat element and the second heat element being independently operable.

11. The griddle recited in claim 1, wherein the griddle is configured to generate a temperature on an outer surface of the griddle plate above 400 degrees Fahrenheit.

12. A griddle configured for use with a liquid heating medium, the griddle comprising:
a griddle plate having an outer surface and an inner surface to define a griddle plate thickness therebetween, the griddle plate thickness being less than 1 inch;
a reservoir body coupled to the griddle plate such that the reservoir body and griddle plate collectively define a reservoir configured to receive a liquid heating medium; and
a heat element in thermal communication with the reservoir and configured to impart heat to the liquid heating medium located within the reservoir.

13. The griddle recited in claim 12, wherein the griddle is configured such that the reservoir is fluidly open to the atmosphere.

14. The griddle recited in claim 12, further comprising at least one dividing wall located within the reservoir to separate the reservoir into two regions.

15. A method of operating a griddle, the method comprising the steps of:
filling a reservoir with a liquid heating medium through a port in fluid communication with the reservoir, the reservoir being defined by a griddle plate and a reservoir body coupled to the griddle plate, the reservoir being filled until the liquid heating medium contacts the griddle plate; and
heating the liquid heating medium with a heat element in thermal communication with the reservoir.

16. The method recited in claim 15, wherein the port is open to the atmosphere during the heating step.

17. The method recited in claim 15, wherein the heat element used in the heating step is an electric heat element.

18. The method recited in claim 15, wherein the heat element used in the heating step is a gas heat element.

19. The method recited in claim 15, wherein the heat clement used in the heating step is located in the reservoir.

20. The method recited in claim 15, wherein the heat clement used in the heating step is located outside of the reservoir.
